(19) United States
(12) Patent Application Publication
(10) Pub. No.: US 2008/0201254 A1
(43) Pub. Date: Aug. 21, 2008

(54) Method and system for computer-implemented procurement from pre-qualified suppliers

(75) Inventors: Balmukund K. Sharma, Santa Clara, CA (US); Alan F. Abola, Oakland, CA (US)

Correspondence Address: GIRARD & EQUITZ LLP;Attn: Alfred A. Equitz, 400 Montgomery Street, Suite 1110, San Francisco, CA, 94104, US

(73) Assignee: Aravo Solutions, Inc.

(21) Appl. No.: 11/709,670

(22) Filed: Feb. 21, 2007

(51) Int. Cl. G06Q 40/00

(52) U.S. Cl. 705/37

(57) ABSTRACT

In preferred embodiments, a supplier enablement method including the steps of identifying and assessing capabilities of potential suppliers; engaging (pre-qualifying) selected potential suppliers; and enabling automated transactions (e.g., purchase orders and billing) between a buyer and each engaged supplier. Preferred embodiments of the method implement supplier enablement in three phases: supplier selection by a buyer; activation of each selected supplier; and management of relationships between the buyer and each selected supplier. Preferably, each phase has three subphases: the supplier selection phase includes identification of potential suppliers; assessment of their capabilities; and engagement of selected potential suppliers; the activation phase includes registration of each engaged supplier; content provision; and enablement of transaction business documents (e.g., purchase orders) for use by each buyer and engaged supplier; and the management phase includes collaboration operations, compliance operations, and improvement operations. Other aspects are processors programmed to perform one or more individual steps of any embodiment of the method, and computer readable media which store code for implementing any embodiment of the method.

### TECHNICAL FIELD OF THE INVENTION

The present invention relates to methods and systems for automated procurement of goods and services. Typical embodiments of the invention are systems and methods for computer-implemented procurement of goods and services from pre-qualified suppliers, including by identifying and assessing capabilities of potential suppliers, engaging (pre-qualifying) selected potential suppliers, enabling automated transactions (e.g., purchase orders and billing) with pre-qualified suppliers (typically via the Internet or another network), and preferably also performing ongoing management of relationships between the buyer and suppliers.

### BACKGROUND OF THE INVENTION

Throughout this disclosure (including in the claims) the terms “vendor” and “supplier” are used as synonyms, the term “buyer” denotes an individual, organization, business enterprise, or other entity that acquires goods and/or services from a supplier, and “service firm” denotes a third-party business (or other third-party entity) providing consulting and/or outsourcing services to a buyer.

It is well known for businesses to employ enterprise resource planning (“ERP”) systems to integrate data and processes into a single unified system. ERP systems typically implement and use a single, unified database that stores data relevant to various aspects of a business enterprise.

Various methods for computer-implemented procurement of goods and services by a buyer are in use. The term “E-procurement” is widely used to denote computer-implemented business-to-business procurement of goods or services via the Internet and other networking systems. It is conventional for a business to use an E-procurement system that is integrated with an ERP system to automate the ordering of goods or services from a vendor over the Internet (e.g., using email and/or website access) and performance of associated invoicing and other accounting operations. In connection with such E-procurement, a vendor typically makes a catalog available electronically to buyer personnel.

However, conventional “E-procurement” systems have not been effective because buyers have not been able to put accurate and sufficient supplier information into these systems. For example, these systems have few catalogs from few suppliers, which frequently are inaccurate or outdated. They do not have accurate supplier profile such as their diversity status, supplier contacts and supplier addresses. Nor have conventional E-procurement systems been compatible with a wide range of different types of information technology (“IT”) systems (e.g.; ERP systems) in common use by buyers, and useful to procure goods and/or services from suppliers of a wide variety of different types, including large suppliers capable of providing catalogs and accepting orders electronically and efficiently (e.g., via website accesses) and small suppliers that do not have resources to establish efficient computer-implemented systems for serving the needs of buyers. Nor have conventional E-procurement systems been sufficiently configurable by (or on behalf of) buyers to meet the needs of a variety of buyers (who may be in a wide range of businesses and may use a wide range of different types of IT systems) to procure goods and services from a variety of suppliers.

### SUMMARY OF THE INVENTION

The expression “supplier enablement” is used herein to denote computer-implemented prequalification or engagement of at least one (typically more than one) supplier so that electronic procurement of goods and/or services by a buyer can occur using an e-Procurement system. In some embodiments, the invention is a supplier enablement system including at least one processor programmed to facilitate assessment of capabilities of potential suppliers and buyer engagement (pre-qualification) of at least one of the potential suppliers, to enable automated procurement transactions between a buyer and each engaged supplier (typically via the Internet), and preferably also to facilitate ongoing management of relationships between the buyer and each engaged supplier. Herein, the expression “procurement transactions” denotes transactions that implement or support procurement of goods or services. Examples of procurement transactions are purchase orders and billing.

In another embodiment, the invention is a supplier enablement method including the steps of: assessing capabilities of potential suppliers; enabling buyer engagement (pre-qualification) at least one of the potential suppliers; and enabling automated procurement transactions between a buyer and each engaged supplier (typically via the Internet). The method preferably also includes the step of performing ongoing management of relationships between the buyer and each engaged supplier. Preferred embodiments of the inventive method implement supplier enablement in three phases: supplier selection by a buyer; activation of each selected supplier; and management of relationships between the buyer and each selected supplier. Preferably, each phase has three subphases:

the supplier selection phase includes identification of potential suppliers; assessment of their capabilities; and engagement of selected potential suppliers;

the activation phase includes “registration” of each engaged supplier (in the sense of collecting data regarding the supplier and providing the collected data (e.g., in the form of a supplier master record or portion of such record) to relevant transaction systems, which may be eProcurement systems, Enterprise Resource Planning (ERP) systems, accounts payable (“A/P”) systems, and marketplace systems); “content” provision (i.e., provision to relevant transaction systems of data regarding each supplier's goods and/or services (e.g., catalogs) and establishment of procedures for ordering such goods and/or services and approval of such orders); and automated exchange of transaction business documents (e.g., purchase orders and eInvoices) between computer systems of the buyer and each engaged supplier; and

the management phase includes collaboration operations (which implement ongoing communication between each buyer, supplier, and relevant third party, typically including on-going maintenance and updating of supplier registration data, announcements and news, change requests, comments, and supplier inquiries), compliance operations (which define and track required actions by each buyer, supplier, and relevant third party, typically including actions to ensure compliance with relevant laws and regulations and buyer standards), and improvement operations (which provide metrics for ongoing improvement of existing buyer-seller relationships and/or improvement of future supplier enablement operations).

Preferably, in the supplier identification sub-phase of the supplier selection phase, at least one programmed processor accesses sources (preferably a wide variety of sources) to identify a pool of supplier candidates. A processor programmed to implement preferred embodiments of the inventive method provides configurable invitation forms that can be selected by a buyer and sent (e.g., by email) to potential suppliers to invite the potential suppliers to provide information specified by the forms. The invitation forms typically ask potential suppliers about their business and technical capabilities, and their qualifications and certifications (e.g., ISO 9000 certification, diversity/minority/small business status, and so on), and are preferably configurable according to needs of the buyer. For example, one form might be configurable to ask an FDA regulated industry supplier if it has been cited by the FDA, and another might be configurable to ask an automotive supplier about their QS9000 quality certification.

Preferably, in the supplier engagement sub-phase of the supplier selection phase, at least one programmed processor determines an appropriate enablement pathway for each selected supplier and generates a checklist (for use by the buyer) of steps required for engaging the supplier (e.g., steps of contacting, training, and verifying contact information) which is implemented through an associated workflow for ensuring and documenting that these steps are performed. Preferably, the workflow is tailored to the specific type of supplier (e.g., a checklist and associated workflow for a strategic supplier should typically be different than for a supplier with whom the buyer expects to place purchase orders only once or twice per year). These workflows are best practices which can be modified based upon the needs of a specific buyer.

Preferably, in the supplier registration sub-phase of the supplier activation phase, at least one programmed processor collects data regarding each selected supplier directly from the supplier and provides the data to multiple transaction systems of the buyer (e.g., eProcurement systems, ERP systems, accounts payable (“A/P”) systems, and marketplace systems). This ensures that all the systems have the same data regarding a supplier and prevents inconsistent and erroneous data across multiple systems. Preferably, the programmed processor is configured to:

generate (and update as needed) a supplier master record for each engaged supplier from collected supplier information (e.g., a master record including name, tax information, multiple supplier contacts, diversity status, bank information, lead times, and addresses of the supplier) in a format usable by any of multiple different types of buyer systems (e.g., eProcurement, ERP, accounts payable or other business systems). Typically, a buyer has multiple business systems, each of which stores information that is relevant to the purpose of the business system. Some of this information might be common across these business systems, such as the supplier tax identification number, while other information is specific to a business system. Preferred embodiments of the inventive method and system generate a supplier master record compatible with any of a variety of information technology (“IT”) systems that may be operated by the buyer. For example, a buyer's enterprise resource planning (“ERP”) system, which is used to order parts from the supplier and make payments to the supplier, may only store “Order-From” and “Pay-To” addresses of the supplier, while a separate Return Material Authorization (RMA) system operated by the buyer is used to capture the “Return-To” and “Bill-To” addresses from the master record;

generate and support a supplier master record (or set of master records) that specifies data for each of multiple sub-units (e.g., locations) of the buyer and/or each of multiple sub-units of each supplier. For example, in the case that a buyer has ten divisions that work with a supplier, the master record (or set of master records) for this supplier includes information that is unique to each division (for example, the supplier master record might specify a different supplier contact person for each buyer division);

generate a configurable supplier master record that can be configured to mimic the model assumed by any of multiple different types of IT systems (e.g., ERP systems) that may be operated by the buyer. Preferably, the processor is programmed to generate configurable registration forms to be completed by suppliers with information needed to generate the supplier master record (each supplier may be asked to access such a registration form at a website, and when the form has been completed by the supplier, the completed form is provided to the processor for use in generating the supplier master record). Preferably, the processor is programmed so that a generic supplier master record can be configured to fit the definitions used by the buyer systems. For example, if the buyer uses SAP ERP software that supports only one location per supplier, the buyer must configure the generic supplier master record to disallow multiple supplier locations. However, if the buyer uses the Oracle ERP software, which supports multiple supplier locations per supplier, the buyer must configure the generic supplier master record to allow multiple supplier locations. In addition, the attributes of a supplier and the associated forms that the suppliers must complete must be configurable to meet the needs of individual business systems;

allow configuration (e.g., by or on behalf of the buyer) of rules for validation of supplier data entry (to ensure that data is accurate when collected from suppliers) to support the validation requirements for the business systems. For example, the processor may run software that determines a configurable registration form for completion by a supplier (to provide data needed for master record generation), and allows the buyer (or a service firm acting on behalf of the buyer) to restrict the maximum length that the supplier user may enter for the supplier name when completing the form to a specific values (e.g., 30 characters) as required by the business systems (e.g. the ERP systems restriction that character length should be less than 30 characters); and

allow configuration by (or on behalf of) the buyer of rules for approval of supplier entered data, and preferably also generation of best practice workflows (consistent with the predetermined rules) to drive the approval process and retain an audit history of approvals for compliance purposes. For example, a processor that implements supplier registration is preferably programmed to allow a buyer (or service firm) to configure a workflow that requires approval of different parts of a supplier master record by different buyer personnel (e.g., vendor certifications may need to be approved by a purchasing professional while bank information may need to be approved by Accounts Payable or Finance department personnel).

In typical embodiments, the inventive system is implemented on a single host computer system (which may be a single host computer operated by the buyer or a third-party host company distinct from the buyer, or more than one host computer, each operated by the buyer or a third-party host). At least one processor of the host computer system runs software configured by (or on behalf of) the buyer and is accessible (e.g., via a web front end) over the internet by the buyer (e.g., so that IT systems of the buyer can access data from a supplier master record). The same processor (or a different processor of the host computer system) is accessible (e.g., via another web front end) over the internet by each supplier. Typically, no supplier computer or supplier-operated IT system is an element of the inventive system, and the only relevant software that runs on supplier computers are internet browsers used by suppliers to access the host computer system (e.g., to complete a registration form that has been generated in accordance with the invention) and conventional business software (e.g., for processing purchase orders received from the buyer or for generating invoices to be transmitted, e.g., by email, to the buyer). Typically also, no buyer computer (or IT system operated by or on behalf of a buyer) is an element of the inventive system, and the only relevant software that runs on computers operated by buyers (or by service firms acting on behalf of buyers) are conventional business software (e.g., for sending purchase orders or other communications to suppliers by email) and internet browsers that access the host computer system. For example, a buyer (or service firm acting on behalf of a buyer) may use a browser to configure software to be run by the host computer system (e.g., to generate a registration form or supplier master record template), by filling in fields in or otherwise responding to menus (e.g., forms or other menus) displayed on the buyer's (or service firm's) computer system. Such menus are determined by data structures generated by the host computer system, and transmitted over the internet for use by the browser to generate the displayed menus.

In a class of embodiments, a service firm coordinates the work between a buyer and the buyer's suppliers and offloads some of the work from the buyer firm. For example, the service firm might review the information submitted by supplier for technical accuracy but leave the final approval step for the buyer. A service firm may also assist a buyer by configuring the software to meet the buyer's needs and performing other steps of the inventive method that would otherwise need to be performed by the buyer. A service firm can be working with multiple buyers and their suppliers and needs to be able to work with each of the buyers and their suppliers in an effective fashion. Preferred embodiments of the invention enable service firm users to share information across multiple buyers and their suppliers. Some embodiments of the invention enable the service firm user to flexibly configure the system (e.g., to flexibly configure workflows determined by the system and/or a generic supplier master record provided by the system and related registration forms to be completed by suppliers) so that some aspects of the configuration are shared across multiple buyers while other aspects are unique. For example, based upon the needs of the buyers, a service firm may decide that one of the workflows is shared by different buyers while another workflow is unique to a specific buyer the service firm is working with.

In some preferred embodiments in which a service firm coordinates work between a buyer and the buyer's suppliers and offloads some of the work from the buyer firm, at least one programmed processor generates a checklist (for use by the buyer) of steps required for at least one operation with respect to a supplier (e.g., the operation of engaging the supplier, including steps of contacting, training, and verifying contact information), to be implemented by an associated workflow. The steps of this operation include at least one step to be performed by the supplier, at least one step to be performed by the service firm, and typically also at least one step to be performed by the buyer. Each such workflow preferably implements best practices which can be modified based upon the needs of a specific buyer. The workflow requires that the entity (e.g., supplier or service firm) that is to perform each step must enter data indicating completion of the step (upon completion of the step), and the processor maintains a record of each such data entry event and provides this record to the buyer (e.g., via interface 22 of FIG. 2 or another interface implemented by a host computer system interface) in response to a request for the record from the buyer. Such a record (or a displayed version thereof) is sometimes referred to as a “dashboard.” Other aspects of the invention are processors and computer systems programmed to perform one or more individual steps of any embodiment of the inventive method, and computer readable media which store code for implementing any embodiment of the inventive method.

### BRIEF DESCRIPTION OF THE DRAWINGS

FIG. 1 is a flow diagram of steps performed during the supplier registration sub-phase of the supplier activation phase of an embodiment of the inventive method

FIG. 2 is a block diagram of a host computer system (20) which is an embodiment of the inventive system, and a buyer computer system (24), a service firm computer system (28), and a supplier computer system (26) connected thereto.

FIG. 3 is an elevational view of a computer readable medium on which is stored computer code for programming at least one processor to perform any embodiment of the inventive method.

### DETAILED DESCRIPTION OF THE PREFERRED EMBODIMENTS

In a class of embodiments, the invention is a method for computer-implemented procurement by a buyer (typically a business enterprise or organization) from at least one (and typically more than one) pre-qualified supplier, including the steps of: identifying and assessing capabilities of potential suppliers; engaging (pre-qualifying) selected potential suppliers; and enabling automated procurement transactions (e.g., purchase orders and billing) with engaged suppliers (typically via the Internet but optionally via another network). In preferred embodiments, the method also includes the step of performing ongoing management of relationships between the buyer and each engaged supplier.

Embodiments of the inventive method implement supplier enablement in three phases: supplier selection by a buyer; activation of each selected supplier; and management of relationships between the buyer and each selected supplier. Preferably, each phase has three subphases:

the supplier selection phase includes identification of potential suppliers; assessment of their capabilities; and engagement of selected potential suppliers;

the activation phase includes “registration” of each engaged supplier (in the sense of collecting data regarding the supplier and providing the collected data to relevant transaction systems, which may be eProcurement systems, Enterprise Resource Planning (ERP) systems, accounts payable (“A/P”) systems, and marketplace systems); “content” provision (i.e., provision to relevant transaction systems of data regarding each supplier's goods and/or services (e.g., catalogs) and establishment of procedures for ordering such goods and/or services and approval of such orders); and automated exchange of transaction business documents (e.g., purchase orders and eInvoices) between computer systems of the buyer and supplier; and

the management phase includes collaboration operations (which implement ongoing communication between each buyer, supplier, and relevant third party, typically including announcements and news, change requests, comments, and supplier inquiries), compliance operations (which define and track required actions by each buyer, supplier, and relevant third party, typically including actions to ensure compliance with relevant laws and regulations and buyer standards), and improvement operations (which provide metrics for ongoing improvement of existing buyer-seller relationships and/or improvement of future supplier enablement operations).

Preferably, in the supplier identification sub-phase of the supplier selection phase, at least one programmed processor accesses sources (preferably a wide variety of sources) to identify a pool of supplier candidates. Casting a broad net ensures that the buyer (e.g., buying organization) leverages its scale (which may be a global scale). A processor programmed to implement preferred embodiments of the inventive method provides configurable invitation forms that can be selected by a buyer and sent (e.g., by email) to potential suppliers to invite the potential suppliers to provide information specified by the forms. The invitation forms typically ask potential suppliers about their business and technical capabilities, and their qualifications and certifications (e.g., ISO 9000 certification, diversity/minority/small business status, and so on), and are preferably configurable according to needs of the buyer. For example, one form might be configurable to ask an FDA regulated industry supplier if it has been cited by the FDA, and another might be configurable to ask an automotive supplier about their QS9000 Quality certification.

Preferably, in the supplier assessment sub-phase of the supplier selection phase at least one programmed processor (operated by the buyer or a third party that compiles relevant data for the buyer) evaluates global supplier candidates against buyer-determined business and technical criteria and confirms information provided by potential suppliers by checking with independent sources. Such an automated (and thus disciplined) evaluation process enables the buyer to find appropriate supplier partners more quickly and efficiently.

Preferably, in the supplier engagement sub-phase of the supplier selection phase, at least one programmed processor determines an appropriate enablement pathway for each selected supplier and generates a checklist (for use by the buyer) of steps required for engaging the supplier (e.g., steps of contacting, training, and verifying contact information) which is implemented through an associated workflow for ensuring and documenting that these steps are performed. Preferably, the workflow is tailored to the specific type of supplier (e.g., a checklist and associated workflow for a strategic supplier should typically be different than for a supplier with whom the buyer expects to place purchase orders only once or twice per year). These workflows are best practices which can be modified based upon the needs of a specific buyer. Use of such a programmed processor in accordance with the invention automates the engagement process, allowing the buyer to more quickly engage suppliers and have visibility into the process.

Preferably, in the supplier registration sub-phase of the supplier activation phase, at least one programmed processor collects data regarding each selected supplier directly from the supplier and provides the data to multiple transaction systems of the buyer (e.g., eProcurement systems, ERP systems, accounts payable (“A/P”) systems, and marketplace systems), thereby ensuring all systems have the same supplier data and prevents inconsistent and erroneous data across multiple systems.

Preferably, the programmed processor is configured to:

generate a supplier master record for each engaged supplier from collected supplier information (e.g., a “Vendor Master” record including supplier name, tax information, multiple supplier contacts, minority status, bank information, lead times, different addresses (e.g., ship-from and remit-to addresses) and preferably to update each such supplier master record), for use by any of multiple different types of buyer systems (e.g., eProcurement, ERP, accounts payable, or other business systems). Typically, a buyer has multiple business systems each of which stores information that is relevant to the purpose of the business system. Some of this information might be common across these business systems, such as the supplier tax identification number while other information is specific to a business system. Preferred embodiments of the inventive method and system generate a supplier master record compatible with any of a variety of IT systems that may be operated by the buyer. For example, if a buyer's enterprise resource planning (“ERP”) system, which is used to order parts from the supplier and make payments to the supplier, may only store “Order-From” and “Pay-To” addresses of the supplier, while a separate Return Material Authorization (RMA) system operated by the buyer is used to capture the “Return-To” and “Bill-To” addresses from the master record;

generate and support a supplier master record that specifies data for each of multiple sub-units (e.g., locations) of the buyer and/or each of multiple sub-units of each supplier. For example, in the case that a buyer has ten divisions that work with a supplier, the master record for this supplier includes information that is unique to each division (for example, the supplier master record might specify a different supplier contact person for each buyer division);

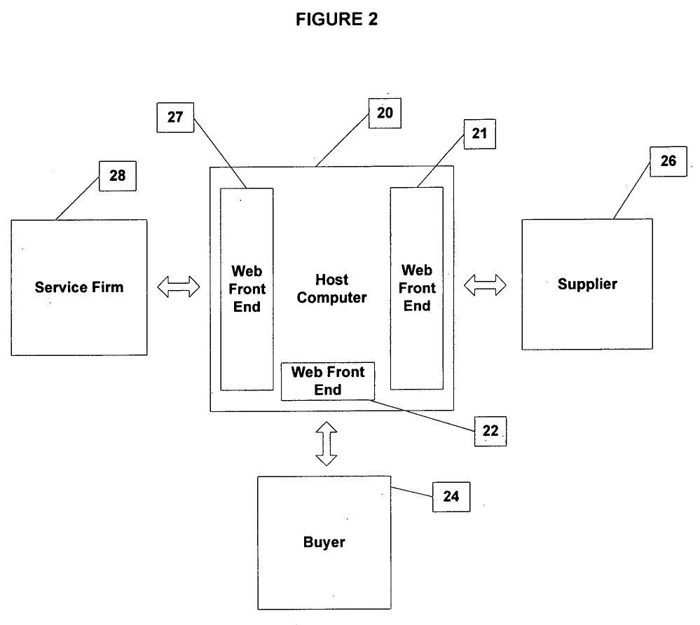

generate a generic (“skeleton”) supplier master record (and a corresponding generic registration form that requires entry of all information needed to generate the generic master record), and to allow the buyer (or a service firm acting on behalf of the buyer) to modify (configure) the generic master record to generate a supplier master record template having user-specified format (e.g., a master record template that, when filled in with supplier data to produce a supplier master record, mimics the model assumed by or is otherwise compatible with each of the buyer's IT systems that will use the supplier master record. The user-specified format can be a buyer-specified format or a format specified by a service firm on behalf of a buyer. The processor can be programmed to configure the generic supplier master record to fit the definitions used by the buyer system. For example, in some embodiments the processor can be programmed to replace the generic registration form with a modified registration form designed to request from the supplier data needed to supplement (e.g., fill in missing fields of) the master record template to generate the supplier master record. For example, the generic supplier master record may have “X” fields, where “X” is a large number (e.g., X may be 50 or 200), for various types of supplier data. In some embodiments, a buyer can conveniently configure software to be run by a host computer system by filling in fields in or otherwise responding to menus (e.g., forms or other menus) displayed on the buyer's computer system (e.g., using interface 22 of FIG. 2 or another interface implemented by the host computer system), to program a processor of the host computer system to specify a master record template (a modified version of the generic supplier master record which has a user-specified format) that requires only a subset of these fields to be filled with data received from the supplier (and optionally also additional fields specified by the buyer), and the processor will then generate appropriate registration form(s) to request only this data from the relevant supplier(s). For example, if the buyer uses ERP software (e.g., SAP ERP software) that supports only one location per supplier but the supplier has N locations, the buyer may cause a generic supplier master record to be replaced by N master record templates (each for a different supplier location, and including only one supplier address). In this case, the supplier is typically required to complete one or more registration forms to provide the data needed to fill in all fields of all N of the master record template. For another example, if the buyer uses ERP software (e.g., Oracle ERP software) which supports multiple supplier locations per supplier, the buyer may configure the generic supplier master record to allow multiple supplier locations. In addition, the attributes of a supplier and the associated forms that the suppliers must complete must be configurable to meet the needs of individual business systems;

allow configuration (e.g., by or on behalf of the buyer) of rules for validation of supplier data entry (to ensure that data is accurate when collected from suppliers) to support the validation requirements for the business systems. For example, the processor may run software that determines a configurable registration form for completion by a supplier (to provide data needed for master record generation), allows the buyer to restrict the maximum length that the supplier user may enter for the supplier name when completing the form to a specific value (e.g., 30 characters), and prevents the supplier from entering a name whose length exceeds the selected value as required by the business systems (e.g., the ERP system's restriction that character length should be less than 30 characters); and

allow configuration by (or on behalf of) the buyer of rules for approval of supplier entered data, and preferably also generation of best practice workflows (consistent with the predetermined rules) to drive the approval process and retain an audit history of approvals for compliance purposes. For example, a processor that implements supplier registration is preferably programmed to allow a buyer (or service firm) to configure a workflow that requires approval of different parts of a supplier master record by different buyer personnel (e.g., vendor certifications may need to be approved by a purchasing professional while bank information may need to be approved by Accounts Payable or Finance department personnel).

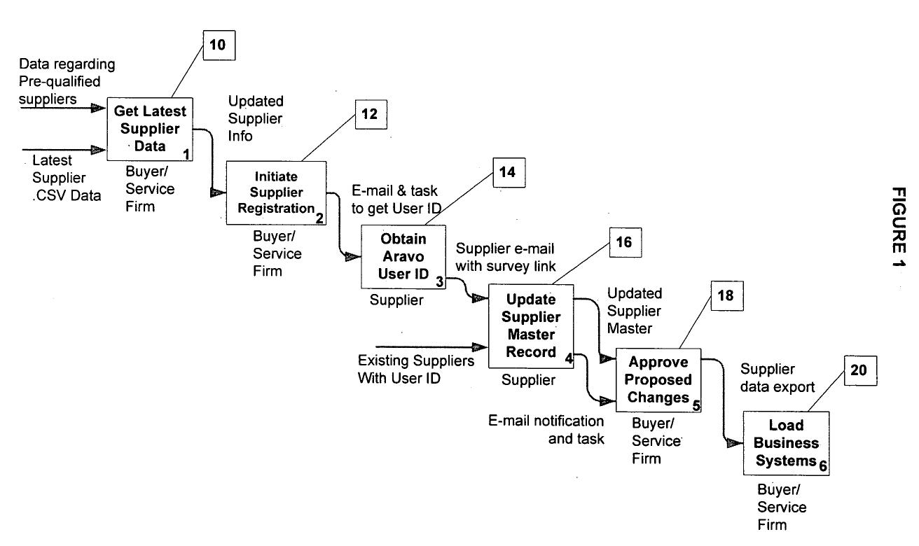

An example of the supplier registration sub-phase of the supplier activation phase will be described with reference to FIG. 1. In this example, existing suppliers are asked to review their existing data for completeness or to correct inaccuracies in the data. In step 10 (labeled “Get Latest Supplier Data”), existing data for pre-qualified suppliers (that have been selected and engaged in a previous supplier selection phase) is extracted from a buyer's ERP system and used to complete fields of a registration form for each such supplier. Also, a supplier registration workflow is initiated by the buyer for each pre-qualified supplier.

The term “workflow” herein denotes a sequence of operations (performed by at least one processor programmed in accordance with the invention) to prompt users to perform a sequence of actions and to document which of the actions have been performed. For example, a processor implementing a workflow may send a sequence of emails to various buyer personnel to notify them and/or obtain approvals from them, and keep a record of which steps of the workflow sequence have been completed. The expression “workflow-implementation program” herein denotes a computer program that can be executed by a processor to perform a workflow.

A processor programmed with a typical embodiment of the inventive software can import supplier data from an ERP system of the buyer or another entity. To do so, mapping may need to be performed between fields in the inventive software and the data being imported (e.g., a field name in the inventive software might be “Zip Code” while the imported data might be identified in the ERP system as “Postal Code”). In typical embodiments, the inventive software provides for such mapping through configuration of the software. The actual data is imported as a spread sheet or comma separated value (CSV) file. Thus, FIG. 1 shows that one format for data used (in step 10) to complete fields of a supplier registration form can be a CSV file.

Step 12 is a first step in implementing the workflow initiated in step 10. In step 12, an e-mail is sent to each selected (pre-qualified) supplier. The email asks the supplier to access a specified link and complete a registration form (sometimes referred to as a “survey”) at a specified website. The supplier then (during step 12) accesses a host computer system (running buyer-configured software including a web front end) via the Internet to access the website. When the supplier has accessed the website, it is asked to accept relevant terms and conditions. When the terms and conditions have been accepted, the supplier is provided a user ID and is asked to choose a password for use in future accesses to the website. After the user ID and password have been provided (in step 14 of FIG. 1), the supplier is taken to a survey page where it is shown a registration form that includes the supplier's existing profile (if one exists). In step 16 of FIG. 1, the supplier fills in fields of the form with requested supplier information, either by entering new information or by confirming or updating an existing supplier profile.

The registration form to be completed by the supplier during step 16 can be determined by a user interface that is implemented by the host computer system (e.g., host computer system 20 of FIG. 2), downloaded (e.g., via interface 21) to the supplier's computer system (e.g., system 26 of FIG. 2), and displayed on the supplier's computer system.

Preferably, a programmed processor of the host computer system applies predetermined, buyer-specified validation rules (configurable validations) during step 16 to ensure that supplier-entered data is accurate and meets the constraints as imposed by business systems such as ERP. For example, one such validation rule may specify that no contact name can have length in excess of twenty characters (or some other predetermined amount). The host computer system allows the supplier representative to review any changes to the data before they submit the data for buyer approval the suppliers The host computer system preferably logs an entire audit history of the supplier-entered data and the identity of each supplier representative who entered the data, and uses the supplier-entered data (which may include or consist of updates to supplier data specified by the registration form asserted to the supplier) to generate a proposed supplier master record for use by the buyer in future transactions with the supplier.

Preferably, the host computer system is configured to generate (and assert to the supplier) a registration form that is dynamic in the sense that at least one question on the form depends on the supplier's answer to a previous question. For example, if the supplier responds to a question by indicating that it supplies customers in the European Union, the dynamic form would request the supplier's Value Added Tax (VAT) registration number.

In step 18, the buyer reviews the proposed supplier master record. Preferably, the proposed supplier master record highlights any changed data in the proposed master record (any data that differs corresponding data in a previous master record for the supplier) by displaying both the old and new values, to assist the buyer in its review. If the buyer approves the proposed master record, relevant data from the master record are loaded back into the buyer's business systems (such as ERP and/or e-Procurement) during step 20. If the buyer rejects the proposed master record with comments, the system resends the survey e-mail to the supplier (with comments indicating the reason for rejection) with a request for submission of new or corrected supplier information.

Preferably, the host computer system is configured to generate a generic (“skeleton”) supplier master record based on how suppliers are defined in the systems used by buyers. For example, a buyer on Oracle ERP would allow suppliers to specify multiple supplier addresses within a single supplier record. However, a buyer on SAP ERP would require each of the supplier addresses to be a different supplier record. This generic master record (which is a configurable template) is conveniently configurable by the buyer (or service firm acting on behalf of the buyer) in the sense that the buyer or service firm can conveniently assert signals to the host computer system (e.g., by filling in fields in or otherwise responding to menus, determined by a “configuration” user interface implemented by the host computer system, that are displayed on a computer system of the buyer or service firm) to cause the host computer system to modify the generic master record to generate a fully configured master record template (sometimes referred to herein as a master record template) for use in place of the generic master record. For example, if supplier locations are allowed in the generic master record, supplier locations can be configured to allow an address, help desk number and fax number. Such a “configuration” user interface may be implemented by host computer system 20 of FIG. 2, and the menus (which may be forms) used by the buyer or service firm to instruct the host computer to modify the generic master record may be downloaded via interface 22 (or interface 27) of FIG. 2 to the buyer's (or service firm's) computer system (e.g., buyer's system 24 or service firm's system 28 of FIG. 2) and displayed on the buyer's (or service firm's) computer system.

Before step 12 is performed, the buyer (or service firm) instructs the host computer system to generate a master record template for use in place of the generic master record. The master record template has format that is compatible with (e.g., mimics the model assumed by) each of the buyer's IT systems that will use a supplier master record to be generated by filling in the template with supplier data. When the buyer or service firm specifies a master record template for use in place of the generic master record, the host computer system typically replaces the generic registration form with a modified registration form designed to request from the supplier the data needed to fill in the master record template to generate a supplier master record having buyer-specified format.

Preferably, the host computer system is pre-configurable by the buyer to require approval from one or more different individuals in a buyer organization during performance of step 18 by the buyer organization to approve a proposed master record. For example, if the supplier is to work with four different business units of the buyer, the system may be preconfigured to require that a representative of each buyer business unit approve data in the proposed master record in order for the proposed master record to receive final approval. Similarly, bank data from the supplier might be approved by the financial department while diversity status data might be approved by the diversity manager.

Preferably, the host computer system is programmed to maintain a schedule for updating each approved supplier master report (and for updating catalog data regarding supplier products). Supplier data such as contact, address and phone number changes frequently and scheduled updates ensure that data does not become inaccurate. Monthly, quarterly, yearly, or other updating may be scheduled. Preferably, the buyer can specify a different update schedule for each supplier and each data type within the supplier, and the host computer system is programmed to automatically trigger a workflow at each scheduled update time to ensure that the report is updated according to schedule. For example, bank data might be reviewed once a year while contacts are reviewed monthly.

Also preferably, the host computer system is programmed to specify different workflows for approval of a proposed master supplier record depending on the supplier's type. For example, the system may require specific approval steps (and thus a specific approval workflow) for a proposed master record for a hazardous material supplier to ensure that safety procedures are followed and banned chemicals don't exist in the supplier's products.

More generally, some embodiments of the invention are supplier enablement methods including the following steps (and systems including at least one processor, which may be included in a host computer system):

(a) asserting at least one registration form to each of at least one pre-qualified supplier, each said supplier being of a known supplier type;

(b) generating at least one supplier master record, having a user-specified format, for at least one said supplier in response to data provided by the supplier in response each said registration form asserted to said supplier;

(c) predetermining at least two workflow-implementation programs, including at least one workflow-implementation program for use in connection with each said supplier having a first supplier type and at least one other workflow-implementation program for use with respect to each said supplier having a second supplier type; and

(d) selecting one of the workflow-implementation programs in response to user specification of the supplier type of one said supplier and executing the selected one of the workflow-implementation programs to implement at least one workflow, thereby implementing at least partially at least one automated procurement transaction pertaining to said supplier. For example, the automated procurement transaction may include approval of the supplier master record for said supplier.

Preferably, the host computer system of a class of embodiments of the invention is programmed to make available to each relevant buyer transaction system (during the content provision sub-phase of the supplier activation phase) data regarding the supplier's goods and/or services (e.g., catalogs). A processor of a host computer system that implements the content provision sub-phase of the supplier activation phase is preferably programmed to provide configurable catalog templates to suppliers (e.g., templates to be completed by a supplier with data, which may include part name, description, and price, to generate a proposed catalog), and such catalog templates preferably apply validation rules that ensure that a supplier can see errors in a proposed catalog as it provides data in response to a catalog template. Preferably, the processor is programmed to perform a best practice workflow process that takes each proposed catalog through an approval process, and the host computer system provides change management tools that identify catalog changes (e.g., added or removed items, and price changes).

Preferably, the enablement sub-phase of the supplier activation phase ensures that transaction business documents (e.g., purchase orders and eInvoices) can be properly transmitted between buyers and the engaged supplier. For example, the host computer system may enforce a ten step enablement process. One of these steps might to validate that a test purchase order can be sent to the supplier. The next step might validate that supplier can acknowledge that the test order was received.

Preferably, in the compliance sub-phase of the management phase, at least one programmed processor (e.g. a programmed processor of the host computer system) defines and tracks required actions by each buyer, supplier, and relevant third party (typically including actions to ensure compliance with relevant laws and regulations and buyer standards) and retains an audit history of changes and approvals for compliance purposes. For example, the processor may track whether each supplier has provided information required by applicable statutes and regulations.

Preferably, in the improvement sub-phase of the management phase, at least one programmed processor provides metrics for ongoing improvement of existing buyer-seller relationships and/or improvement of future supplier enablement operations. For example, the processor may generate historical statistics or monthly trend charts(and cause them to be stored for later access by the buyer) regarding how long it takes to engage and activate a supplier and for suppliers to provide and update catalogs.

In some embodiments, the invention is a supplier enablement system including means for assessing capabilities of the potential suppliers and engaging (pre-qualifying) at least one of the potential suppliers, and means for enabling automated procurement transactions (e.g., purchase orders and billing) with each engaged supplier (e.g., via the Internet or another network). The means for assessing and engaging may be a processor (or more than one processor) programmed to facilitate the assessment of capabilities of potential suppliers and buyer engagement of at least one of the potential suppliers. In preferred embodiments, the system also includes means for performing ongoing management of relationships between the buyer and engaged suppliers.

FIG. 2 is a block diagram of a host computer system (20) which is an embodiment of the inventive system, and a buyer computer system 24, a service firm computer system 28, and a supplier computer system 26 connected thereto (as shown) by the internet. Optionally, service firm computer system 28 is omitted. Host computer system 20 may include single programmed processor (a host computer) operated by the buyer or a third-party distinct from the buyer and each supplier, or two or more programmed processors (e.g., a network of computers) each operated by the buyer or a third-party host. Each of computer systems 24, 26 and 28 may be a single programmed computer or a number of networked programmed computers. At least one processor of host computer system 20 runs buyer-configured software, and the same processor (or a different processor of host computer system 20) includes an interface 22 that is accessible by buyer system 24 via the internet (or another network or link), for example so that IT systems of the buyer can access data from a supplier master record stored on host computer system 20. Interface 22 may be (or include) a web front end configured to allow buyer system 24 to access host computer system 20 via the internet. The same processor (or a different processor) of host computer system 20 includes an interface 21 that is accessible by supplier system 26 via the internet (or another network or link). Interface 21 may be or include a web front end (distinct from interface 22) configured to allow supplier system 26 to access host computer system 20 via the internet. The same processor (or a different processor) of host computer system 20 includes an interface 27 that is accessible by service firm system 28 via the internet (or another network or link). Interface 27 may be or include a web front end (distinct from interface 22 and 21) configured to allow service firm system 28 to access host computer system 20 via the internet. Although only one buyer computer system 24 is shown, host computer system 20 is configured so that more than one buyer computer system may access host computer system 20. Although only one supplier computer system 26 is shown, host computer system 20 is configured so that more than one supplier computer system (operated by or for a single supplier or a number of different suppliers) may access host computer system 20. Although only one service firm computer system 28 is shown, host computer system 20 is configured so that more than one service firm system may access host computer system 20.

Some embodiments of the inventive system include only a host computer system (which runs software for implementing steps of an embodiment of the inventive method) and optionally also a buyer and/or service firm computer system (which runs software for implementing steps of such embodiment of the inventive method); not a supplier computer or supplier-operated IT system. In such embodiments, the only relevant software that runs on supplier computers are browsers used by suppliers to access the inventive host computer system (e.g., to complete a registration form that has been generated in accordance with the invention) and conventional application software (e.g., for processing purchase orders received from the buyer or for generating invoices to be transmitted to the buyer by email).

As mentioned earlier, the inventive software is preferably configurable in several respects in accordance with the buyer's needs. Preferably, it is configurable without writing custom code (e.g., so that a user can select a selectable field entitled “lead time” for inclusion in a catalog template to be completed by a supplier to provide a catalog of the supplier's goods, to cause the supplier to specify a lead time for ordering each item in the catalog). In some embodiments, such configuration is performed by an employee of a service firm engaged by a buyer to configure the software in accordance with the buyer's needs and to interface with a host computer system that runs the configured software. Where the configuration is performed by an employee of a service firm, the service firm may choose to leverage the same configuration (or parts of the configuration) for each of multiple buyers (all engaged by the same service firm). For example, a best practice workflow can be defined once by the service firm and used across multiple buyers. While parts of configuration are shared, other parts of configuration can be different (e.g., so that some buyers require their suppliers to provide a “lead time” for all products listed in a catalog but other buyers do not).

In a class of embodiments in which a service firm coordinates work between a buyer and the buyer's suppliers and offloads some of the work from the buyer firm, at least one programmed processor (e.g., a processor of host system 20 of FIG. 2) generates a checklist (for use by the buyer) of steps required to perform at least one operation with respect to a supplier (e.g., the operation of engaging the supplier, including steps of contacting, training, and verifying contact information), to be implemented by an associated workflow. The steps of the operation include at least one step to be performed by the supplier, at least one step to be performed by the service firm, and typically also at least one step to be performed by the buyer. Each such workflow preferably implements best practices which can be modified based upon the needs of a specific buyer. The workflow requires that the entity (e.g., supplier or service firm) that is to perform each step must enter data (i.e., provide the data to the processor) indicating completion of the step (upon completion of the step). The processor maintains a record of each such data entry event and provides this record to the buyer (e.g., via interface 22 of FIG. 2 or another interface implemented by a host computer system interface) in response to a request for the record from the buyer. Such a record (or a displayed version thereof) is sometimes referred to as an “executive dashboard.” The executive dashboard is preferably an online web page that summarizes the state of completion of the relevant process across the relevant entities (e.g., supplier, buyer, and service firm).

In a class of embodiments, application software to be run on a processor of a host computer system to perform the inventive method is configurable by a service firm in at least the following respects:

workflows, email templates, and reminder/notification functionality are configurable (e.g., to define steps in a workflow, and to define what happens or who is notified when a workflow is started, and when each step of the workflow is completed);

a generic supplier master record (a “skeleton” supplier object) and a generic registration form (that requires entry by a supplier of all information needed to generate the generic master record) is configurable to be compatible with (e.g., to mimic the model assumed by any) each of a buyer's IT systems that will use the master record. For example, a buyer's IT system (e.g., ERP system) may assume a data model that supports multiple locations for each supplier (e.g., a supplier record can specify supplier offices in New York and Chicago) while another buyer's IT system does not. For another example, a buyer's IT system (e.g., ERP system) may support separating financial data from purchasing data, while another buyer's IT system does not. Preferably, the application software can be configured by the service firm to implement high level generic definition (e.g., whether multiple locations for a supplier are allowed or not) and enable users to fill in the detailed structure of the master record or registration form (e.g., to specify an address and a contact person for each supplier location). Detailed structure is preferably added by defining the “attributes” or fields (such as address and contact person) comprising a supplier definition. Preferably, configurable validation rules ensure that a supplier can see the errors in its responses to the registration form as it completes the registration form (e.g., a registration form may require that a Tax ID for a supplier must be a number less than 1,000,000 but cannot be a negative number, and that a supplier name cannot be more than 30 characters);

a catalog template is configurable (e.g., for completion by the supplier with configurable fields for part name, description, price per unit, and other product attributes to generate a proposed catalog, and to apply configurable validation rules that ensure that a supplier can see errors in a proposed catalog as it completes the catalog template). Preferably, a best practice workflow process takes each proposed catalog through a configurable approval process, and change management tools are provided in accordance with the invention to identify catalog changes (e.g., added or removed items, and price changes); and

various other forms to be filled out by end users are configurable.

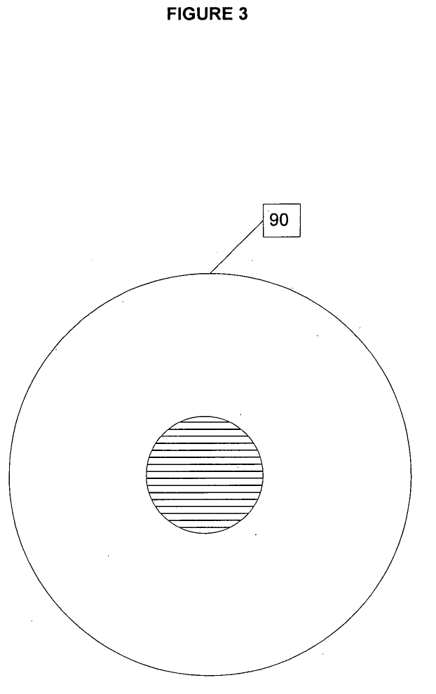

FIG. 3 is an elevational view of a computer readable medium (90), which may be an optical disk or set of optical disks, on which is stored computer code for programming at least one processor to perform any embodiment of the inventive method.

Although the invention has been described in connection with specific preferred embodiments, various modifications of and variations on the described methods and apparatus of the invention will be apparent to those skilled in the art without departing from the scope and spirit of the invention.

What is claimed is:

1. A supplier enablement method, including the steps of:
(a) asserting at least one registration form to each of at least one pre-qualified supplier, each said supplier being of a known supplier type;
(b) generating at least one supplier master record, having a user-specified format, for at least one said supplier in response to data provided by the supplier in response each said registration form asserted to said supplier;
(c) predetermining at least two workflow-implementation programs, including at least one workflow-implementation program for use in connection with each said supplier having a first supplier type and at least one other workflow-implementation program for use with respect to each said supplier having a second supplier type; and
(d) selecting one of the workflow-implementation programs in response to user specification of the supplier type of one said supplier and executing the selected one of the workflow-implementation programs to implement at least one workflow, thereby implementing at least partially at least one automated procurement transaction pertaining to said supplier.

2. The method of claim 1, wherein the automated procurement transaction includes approval of the supplier master record for said supplier.

3. The method of claim 1, wherein the user-specified format is a buyer-specified format.

4. The method of claim 1, wherein the user-specified format is a format specified by a service firm on behalf of a buyer.

5. A supplier enablement system, including at least one processor programmed to:
provide at least one registration form for use by each of at least one pre-qualified supplier, each said supplier being of a known supplier type;
generate at least one supplier master record, having a user-specified format, for at least one said supplier in response to data provided by the supplier in response each said registration form asserted to said supplier;
execute any selected one of at least two workflow-implementation programs, including at least one workflow-implementation program for use in connection with each said supplier having a first supplier type and at least one other workflow-implementation program for use with respect to each said supplier having a second supplier type; and
selecting one of the workflow-implementation programs in response to user specification of the supplier type of one said supplier and executing the selected one of the workflow-implementation programs to implement at least one workflow, thereby implementing at least partially at least one automated procurement transaction pertaining to said supplier.

6. The system of claim 5, wherein the user-specified format is a buyer-specified format.

7. The method of claim 5, wherein the user-specified format is a format specified by a service firm on behalf of a buyer.

8. A supplier enablement method, including the steps of:
(a) asserting at least one registration form to each of at least one pre-qualified supplier;
(b) generating at least one supplier master record, having a user-specified format, for at least one said supplier in response to data provided by the supplier in response each said registration form asserted to said supplier; and
(c) before steps (a) and (b), configuring a generic supplier master record to determine a master record template having the user-specified format.

9. The method of claim 8, also including the steps of:
(d) before step (a), assessing capabilities of potential suppliers and pre-qualifying at least one of the potential suppliers; and
(e) after step (b), enabling electronic procurement transactions between a buyer and each supplier for which at least one said one supplier master record and at least one catalog have been generated.

10. The method of claim 9, wherein the electronic procurement transactions include purchase orders and at least one billing transaction.

11. The method of claim 9, also including the step of:
before step (a), sending to each said pre-qualified supplier at least one emailed request that the pre-qualified supplier access a specified website to register as a supplier, and
wherein the at least one registration form is asserted to the pre-qualified supplier during step (a) following at least one access by the pre-qualified supplier to the website.

12. The method of claim 8, wherein a programmed processor generates each said supplier master record, and step (c) includes the step of programming the processor to modify the generic master record to determine the master record template.

13. The method of claim 12, wherein the programmed processor generates each said registration form asserted during step (a) such that each said registration form requests data needed to supplement the master record template to generate at least one said supplier master record.

14. The method of claim 12, wherein one said supplier master record includes data indicative of each of multiple sub-units of one said supplier.

15. The method of claim 12, wherein step (a) includes the step of asserting at least one said registration form to a pre-qualified supplier having multiple sub-units, and step (b) includes the steps of:
generating a first supplier master record for one of the sub-units, said first supplier master record including data indicative of said one of the sub-units; and
generating a second supplier master record for a second one of the sub-units, said second supplier master record including data indicative of the second one of the sub-units.

16. The method of claim 8, wherein each said registration form requests data needed to supplement the master record template to generate at least one said supplier master record, and one said supplier master record includes data indicative of each of multiple sub-units of one said supplier.

17. The method of claim 8, wherein step (a) includes the step of asserting at least one said registration form to a pre-qualified supplier having multiple sub-units, and step (b) includes the steps of:
generating a first supplier master record for one of the sub-units, said first supplier master record including data indicative of said one of the sub-units; and
generating a second supplier master record for a second one of the sub-units, said second supplier master record including data indicative of the second one of the sub-units.

18. The method of claim 8, wherein the generic supplier master record is configurable to have format compatible with any of multiple different types of business systems.

19. The method of claim 8, wherein the generic supplier master record is configurable to have format compatible with any of multiple different types of enterprise resource planning systems, and the user-specified format is compatible with one of these enterprise resource planning systems.

20. The method of claim 8, also including the step of:
generating each said registration form asserted during step (a) such that said registration form implements a selected one of a number of available rules for validating data entered by a supplier during supplier completion of said registration form.

21. The method of claim 8, also including the step of:
(d) approving each said supplier master record generated during step (b), by performing a workflow determined before performing step (a).

22. The method of claim 21, wherein the workflow requires approval of different parts of the supplier master record by different buyer personnel.

23. The method of claim 8, wherein the user-specified format is a buyer-specified format.

24. The method of claim 8, wherein the user-specified format is a format specified by a service firm on behalf of a buyer.

25. A computer system, including at least one processor programmed to perform supplier enablement operations including by providing a generic supplier master record, generating a master record template having a buyer-specified format as a result of user configuration of the generic supplier master record, asserting to each of at least one pre-qualified supplier data determining at least one registration form, and generating at least one supplier master record, having the buyer-specified format, for at least one said supplier in response to data provided by the supplier in response to at least one said registration form, wherein the at least one processor is configured and programmed to implement:
a buyer interface configured to generate data structures that, when asserted to a user computer system operated by at least one of a buyer and a service firm, determine at least one master record configuration menu for display on the user computer system, wherein the buyer interface is also configured to cause said at least one processor to generate the master record template in response to signals asserted from the user computer system in response to display of the at least one master record configuration menu; and
a second interface configured to generate data structures that, when asserted to a supplier computer system operated by one said supplier, determine at least one said registration form for display on the supplier computer system, wherein the second interface is also configured to cause said at least one processor to generate at least one said supplier master record in response to signals asserted from the supplier computer system in response to display of at least one said registration form.

26. A supplier enablement system, including at least one processor programmed to:
generate a master record template having user-specified format in response to at least one command specifying configuration of a generic supplier master record, assert data indicative of at least one registration form to at least one pre-qualified supplier, and
generate at least one supplier master record, having the user-specified format, for at least one said supplier in response to data provided to the at least one processor by the supplier in response to at least one said registration form.

27. The system of claim 26, wherein the at least one processor is also programmed to:
send to each said pre-qualified supplier at least one emailed request that the pre-qualified supplier access a specified website to register as a supplier, and assert data indicative of at least one said registration form to each said pre-qualified supplier following an access by the pre-qualified supplier to the website.

28. The system of claim 26, wherein each said registration form requests data needed to supplement the master record template to generate at least one said supplier master record, and the at least one processor is also programmed to generate one said supplier master record that includes data indicative of each of multiple sub-units of one said supplier.

29. The system of claim 26, wherein the at least one processor is programmed to:
assert data indicative of at least one said registration form to a pre-qualified supplier having multiple sub-units;
generate a first supplier master record for one of the sub-units, said first supplier master record including data indicative of said one of the sub-units; and
generate a second supplier master record for a second one of the sub-units, said second supplier master record including data indicative of the second one of the sub-units.

30. The system of claim 26, wherein the generic supplier master record is configurable to have format compatible with any of multiple different types of business systems.

31. The system of claim 26, wherein the generic supplier master record is configurable to have format compatible with any of multiple different types of enterprise resource planning systems, and the user-specified format is compatible with one of these enterprise resource planning systems.

32. The system of claim 26, wherein the at least one processor is programmed to generate the data indicative of each said registration form such that said registration form implements a selected one of a number of available rules for validating data entered by a supplier during supplier completion of said registration form.

33. The system of claim 26, wherein the at least one processor is programmed to perform a workflow to accomplish automated approval of each said supplier master record.

34. The system of claim 26, wherein the workflow requires approval of different parts of the supplier master record by different buyer personnel.

35. The system of claim 26, wherein the at least one processor is programmed to implement a buyer interface configured to generate data structures that, when asserted to a user computer system operated by at least one of a buyer and a service firm, determine at least one master record configuration menu for display on the user computer system, wherein the buyer interface is also configured to cause said at least one processor to generate the master record template in response to signals asserted from the user computer system in response to display of the at least one master record configuration menu.

36. The system of claim 35, wherein the master record template has a skeleton, and the signals asserted from the user computer system in response to display of the at least one master record configuration menu determine high level definition of the skeleton and specify at least one field of the master record template to be supplemented by data to generate at least one said supplier master record from the master record template.

37. The system of claim 26, wherein the at least one processor is programmed to perform at least one workflow consisting of steps determined by at least one configuration command from at least one of a buyer and a service firm.

38. The system of claim 26, wherein the at least one processor is programmed to assert at least one email message having format determined by configuration of an email template in response to at least one configuration command from at least one of a buyer and a service firm.

39. The system of claim 26, wherein the user-specified format is a buyer-specified format.

40. The method of claim 26, wherein the user-specified format is a format specified by a service firm on behalf of a buyer.

41. A computer readable medium which stores code for programming at least one processor to perform the steps of:
(a) asserting data indicative of at least one registration form to each of at least one pre-qualified supplier;
(b) generating at least one supplier master record, having a user-specified format, for at least one said supplier in response to data provided by the supplier in response each said registration form asserted to said supplier; and
(c) before steps (a) and (b), configuring a generic supplier master record to determine a master record template having the user-specified format.

42. The medium of claim 41, wherein said medium also stores code for programming the at least one processor to perform the steps of:
before step (a), sending to each said pre-qualified supplier at least one emailed request that the pre-qualified supplier access a specified website to register as a supplier, and to assert the data indicative of at least one registration form to the pre-qualified supplier during step (a) following at least one access by the pre-qualified supplier to the website.

43. The medium of claim 41, wherein said medium also stores code for programming the at least one processor to generate the data indicative of at least one registration form such that each said registration form requests data needed to supplement the master record template to generate at least one said supplier master record.

44. The medium of claim 43, wherein said medium stores code for programming the at least one processor such that one said supplier master record includes data indicative of each of multiple sub-units of one said supplier.

45. The medium of claim 43, wherein said medium stores code for programming the at least one processor to assert data indicative of at least one said registration form to a pre-qualified supplier having multiple sub-units, and such that step (b) includes the steps of:
generating a first supplier master record for one of the sub-units, said first supplier master record including data indicative of said one of the sub-units; and
generating a second supplier master record for a second one of the sub-units, said second supplier master record including data indicative of the second one of the sub-units.

46. The medium of claim 41, wherein said medium stores code for programming the at least one processor to generate data indicative of each said registration form such that said registration form implements a selected one of a number of available rules for validating data entered by a supplier during supplier completion of said registration form.

47. The medium of claim 41, wherein said medium stores code for programming the at least one processor to perform a workflow to accomplish automated approval of each said supplier master record, wherein the workflow requires approval of different parts of the supplier master record by different buyer personnel.

48. The medium of claim 41, wherein said medium stores code for programming the at least one processor to generate the master record template in response to at least one command from at least one of a buyer and a service firm specifying configuration of the generic supplier master record.

49. The medium of claim 48, wherein the master record template has a skeleton, and the at least one command specifying configuration implements high level definition of the skeleton and specifies at least one field of the master record template to be supplemented by data to generate at least one said supplier master record from the master record template.

50. The medium of claim 41, wherein said medium stores code for programming the at least one processor to perform at least one workflow consisting of steps determined by at least one configuration command from at least one of a buyer and a service firm.

51. The medium of claim 41, wherein the user-specified format is a buyer-specified format.

52. The medium of claim 41, wherein the user-specified format is a format specified by a service firm on behalf of a buyer.

53. A supplier enablement method, including the steps of:
asserting at least one registration form to each of at least one pre-qualified supplier;
generating at least one supplier master record for at least one said supplier in response to data provided by the supplier in response each said registration form asserted to said supplier;
generating a checklist of steps required for performing at least one operation with respect to the supplier to be implemented by a workflow, wherein the steps include at least one step to be performed by the supplier and at least one step to be performed by a service firm, and the workflow requires that each entity to perform at least one of the steps must enter data indicating completion of said at least one of the steps, and
maintaining a record of each event of entry of said data and providing the record to a buyer in response to a request for the record from the buyer.

54. The method of claim 53, wherein the operation is engagement of the supplier, and said operation includes steps of contacting the supplier, training the supplier, and verifying contact information of the supplier.

55. A supplier enablement system, including at least one processor programmed to:
assert at least one registration form to each of at least one pre-qualified supplier;
generate at least one supplier master record for at least one said supplier in response to data provided by the supplier in response each said registration form asserted to said supplier;
generate a checklist of steps required for performing at least one operation with respect to the supplier to be implemented by a workflow, wherein the steps include at least one step to be performed by the supplier and at least one step to be performed by a service firm, and the workflow requires that each entity to perform at least one of the steps must enter data indicating completion of said at least one of the steps, and maintain a record of each event of entry of said data and provide the record to a buyer in response to a request for the record from the buyer.
